(19) United States
(12) Patent Application Publication
(10) Pub. No.: US 2009/0195704 A1
(43) Pub. Date: Aug. 6, 2009

(54) POWER SAVING DEVICE

(75) Inventor: Hugo Bombara, Nedlands Western Australia (AU)

Correspondence Address: NIXON & VANDERHYE, PC, 901 NORTH GLEBE ROAD, 11TH FLOOR, ARLINGTON, VA, 22203, US

(73) Assignee: QWIND PTY LTD, Nedlands Western Australia (AU)

(21) Appl. No.: 12/205,324

(22) Filed: Sep. 5, 2008

(30) Foreign Application Priority Data
Feb. 6, 2008 (AU) 2008900549
Mar. 11, 2008 (AU) 2008901151
May 22, 2008 (AU) 2008902529

(51) Int. Cl. H04N 5/44

(52) U.S. Cl. 348/734; 348/E05.096

(57) ABSTRACT

A television control device including: a housing including a motion detector and a controller; the controller having a first facility that anticipates a state of a television and a second facility that sends a wireless signal to the television, wherein the first facility changes a state of the controller between a first controller state and a second controller state and the second facility selectively sends a predetermined wireless signal to the television, depending on the state of the controller, in response to an absence of movement during period of time being detected by the motion detector.

### RELATED APPLICATIONS

The application claims priority to Australian Provisional Application Nos. 2008-902529 filed 22 May 2008, 2008-901151 filed 11 Mar. 2008 and 2008-900549 filed 6 Feb. 2008, the entirety of each which applications are incorporated by reference.

### FIELD OF THE INVENTION

The present invention relates to control and power saving devices. In one preferred form, there is provided a television power saving device.

### BACKGROUND TO THE INVENTION

Remote controls are well known for changing the channels of televisions, changing their volume, changing their display characteristics and so forth. With the increased demand for electricity and the associated economic and environmental costs of energy use, reducing unnecessarily electricity usage is becoming an issue of increasing importance.

Televisions are one such example of an electrical appliance which may often be left running when not required. For example, it is common for televisions to be left on for periods ranging from short periods, such as when the viewer leaves the room briefly, to extended periods of time. With the increasing usage of LCD and plasma flat screen televisions, which have a relatively large power consumption compared to standard CRT televisions, leaving televisions on when no one is watching can be a significant source of wasted energy. Such flat screen televisions also have a relatively high heat output which adds further to electricity usage when an air conditioning system is running in the same area as the television. A problem of high electricity usage is compounded by the relatively recent development of there being several plasma or LCD televisions in average consumer households.

### SUMMARY OF THE INVENTION

A power saving device has been developed for switching off an electrical appliance having a receiver for receiving signals, including an off signal, from an associated remote control, the power saving device comprising: a motion sensor for detecting the presence of a person in the vicinity of the appliance; and a transmitter for replicating the off signal of the remote control; wherein in the event that the motion sensor does not detect the presence of a person in the vicinity of the appliance for a predetermined time period, the transmitter sends the off signal to turn off the appliance.

In one embodiment, the electrical appliance comprises a television and the transmitter sends the off signal to the television after the predetermined time has elapsed to turn off the television display.

The power saving device may include a signal receiver to receive the off signal from the remote control of the television and store information regarding the off signal in a memory for use. The power saving device may include a store button which when depressed puts the power saving device into a store mode in which the off signal is received by the signal receiver and stored in memory.

Preferably, the power saving device includes a mode button for changing the power saving device between an active mode and a standby mode. The power saving device is preferably provided with a status light which indicates the current mode of the power saving device.

Preferably a means is provided for the user to vary the predetermined time period after which the transmitter sends the off signal. The predetermined time period may include a warning period before the end of the predetermined time period in which the status light is flashed.

Preferably the power saving device switches to the standby mode on sending the off signal to the television. Further, the power saving device preferably switches to the active mode on the signal receiver receiving an on signal from the remote control.

The power saving device may be provided with a means to determine the state of the television display. In one embodiment, the means to determine the state of the television display may comprise a display detection means to detect signals generated by the television when the display is on.

A television control device has been developed comprising: a housing including a motion detector and controller, the controller comprising a first facility for anticipating the state of a television; and a second facility for sending a wireless signal to the television; wherein the first facility is adapted for changing the state of the controller, between a first state and a second state; and the second facility is adapted for selectively sending a predetermined wireless signal to the television, depending on the state of the controller, in response to the absence of movement for period of time being detected with the use of the motion detector.

Preferably the first facility comprises a receiver adapted to receive a predetermined wireless television signal issued from a television remote control and change the state of the controller upon the predetermined wireless signal being received. Preferably the second facility is adapted for selectively sending the same predetermined wireless signal to the television.

The first facility may comprise a video detection unit adapted for physically detecting the presence of visible light originating from the television.

The first facility may comprise an audio detection unit adapted for physically detecting audio waves originating from a speaker associated with the television.

The first facility may comprise a current detection unit adapted for physically detecting current running through a power cord supplying power to the television.

The first facility may comprise a current detection unit adapted for physically detecting current running through an electrical cord associated with the television.

Preferably the television control device includes a threshold facility for ensuring that the absence of movement is detected only when predetermined criteria are satisfied.

Advantageously in preferred embodiments the threshold facility is adapted to ensure that the amount of movement required for the presence of movement to be detected, increases with time. This is considered to be particularly advantageous in respect of people sleeping in front of a television.

Preferably the television control device is able to be positioned adjacent either side of a television receiver built into the television.

A television control device has been developed comprising: a housing including a motion detector and a controller; the controller including a transmitter for sending a predetermined wireless signal for controlling state of a television and a memory for storing a value indicative of an anticipated state of the television; the housing arranged to stand upwardly and provide an elevated platform; the platform providing a depressible state selection button for allowing the user to change the value indicative of the anticipated state of the television.

Preferably the housing is arranged to extend at least 7 cm into the air and the state selection button is sized to be pressed with the underside of a person's index finger. Preferably the device includes a receiver for receiving the predetermined wireless signal from a television remote control, the receiver being connected to the memory for changing the stored value in anticipation of a change in state of the television.

A control device has been developed comprising: a housing including a motion detector and controller, the controller comprising a first facility used for anticipating the state of a remote apparatus; and a second facility for sending a wireless signal to a second remote apparatus associated with a display; wherein the first facility is adapted for changing the state of the controller, between a first and a second state; and the second facility is adapted for selectively sending a predetermined wireless signal to the second remote apparatus, depending on the state of the controller, in response to the absence of movement for period of time being detected using the motion detector.

A method has been developed of controlling a television comprising: providing a control device having a motion detector and a controller; receiving a predetermined signal from a remote control device and changing the state of the controller in accordance therewith; sensing the absence of a movement for a predetermined amount of time; and once the absence of movement has been detected, wirelessly sending the predetermined wireless signal to a television, depending on the state of the controller.

Preferably the method includes applying a threshold to ensure that the presence of movement is detected only when the movement meets predetermined criteria.

Advantageously the preferred embodiments disclosed herein provide a number of advantageous system and methods. It is considered that advantageous systems and methods are at least provided in the following circumstances:

When a person falls asleep in front of a television, the quality of their sleep is known to be affected by the video and audio signals being sent from the television. It is thought that these signals are interpreted subliminally by the person who experiences interrupted sleep patterns as a result. Advantageously the preferred embodiments disclosed herein provide a threshold facility for ensuring that motion of a sleeping person is at least very rarely detected as being present. In advantageous arrangements the threshold unit ensures that an increasing level of motion corresponds with the presence of a person as time progresses.

An increasing number of houses have more than one television. Often children have televisions in their rooms which when left on, and disturb their parents. Preferred arrangements allow for the reduced levels of noise.

Average size plasma and LCD televisions may consume about 300 W of power while larger version of these device may consume upwards of 600 W. When several televisions in a household are being watched the total consumption may be upwards of 1200 W. Preferred arrangements of the disclosed embodiments are considered to have a considerable environmental benefit.

Remote control devices often have a multitude of buttons and are difficult to use. In the case of remote control sleep timers, they are known to require complicated sequences of button presses. Furthermore, people often do not activate sleep timers as they rarely acknowledge that they are about to fall asleep. Even then, when a sleep timer has been activated, it is difficult to reset the time in the dark using the remote control.

Preferred arrangements of the control devices disclosed herein are readily positioned on either side of a television with a central receiver a lower panel. This means the device does not have to be positioned on coffee table where the device may be knocked over. In preferred arrangements, the device also provides a ready access platform having one or two buttons.

### BRIEF DESCRIPTION OF THE DRAWINGS

The nature of the invention will be better understood from the following detailed description of several specific embodiments, given by way of example only, with reference to the accompanying drawings, in which:

FIG. 1 is a front perspective view of a power saving device;

FIG. 2 is a rear perspective view of the power saving device of FIG. 1;

FIG. 3 is a side view of the power saving device in use controlling a television;

FIG. 4 is a schematic view of another power saving device;

FIGS. 5a and 5b comprise several views of the device shown in FIG. 4;

FIG. 6 is a top view of the device shown in FIG. 4 and

FIG. 7 is a schematic view of a method for the operation of the power saving devices disclosed herein.

### DETAILED DESCRIPTION OF PREFERRED EMBODIMENTS

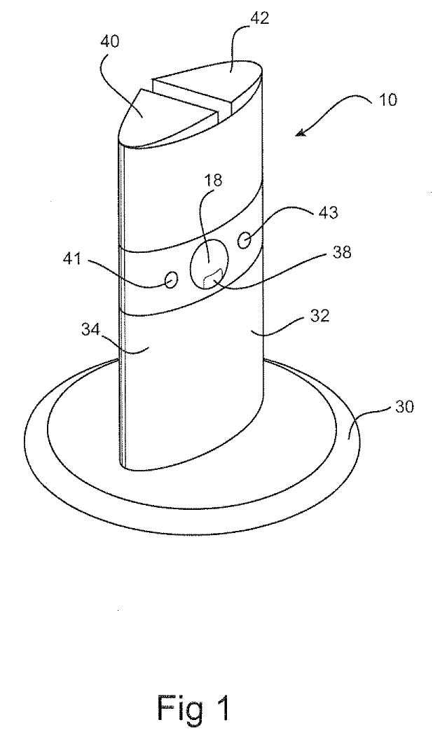

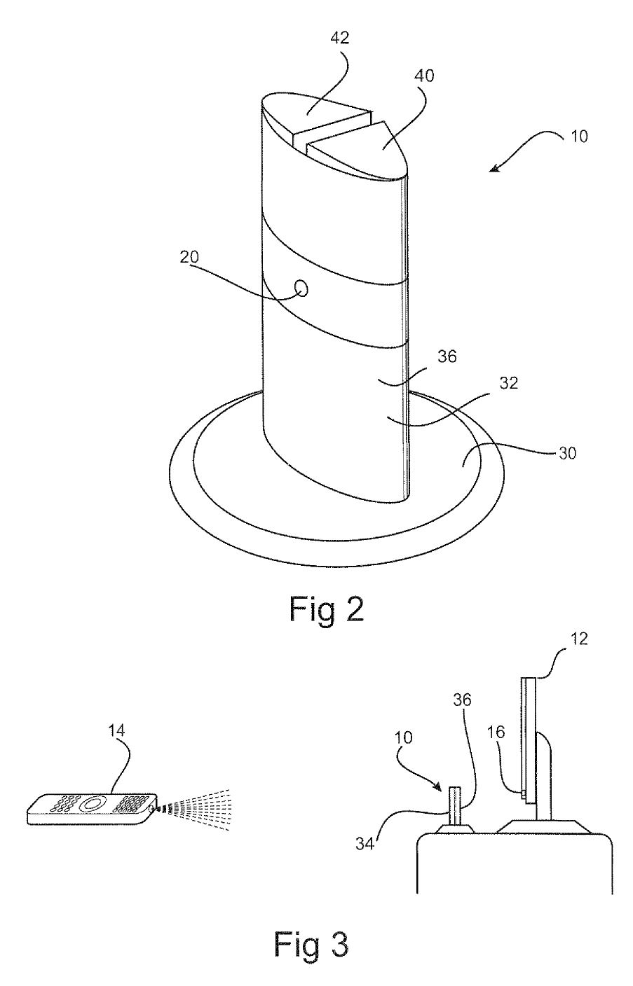

FIGS. 1 and 2 show a power saving device 10 including a portable unit which can be placed in the vicinity of an electrical appliance, such as a television 12.

The power saving device 10 is to be used to reduce power consumption of appliances which are controlled using a remote control 14. The remote control 14 comprises a standard television remote for controlling operation of the television 12, including the ability to turn the television display off by sending an off signal. Signals transmitted by the remote control 14 are received by a receiver 16 on the television 12.

As shown in FIG. 3, the power saving device 10 is designed to stand in front of the television 12. The power saving device 10 comprises a base 30 and a housing 32 extending upwardly from the base 30.

The power saving device 10 includes a motion sensor capable of detecting the presence of a person in the vicinity of the television 12. The motion sensor may utilize any suitable method of detecting motion to determine whether a person is in the vicinity of the television 12, such as an infrared or microwave sensor. The sensitivity of the motion sensor may be adjustable. The circuitry for the motion sensor is contained within the housing 32 and a sensor element 18 is provided on a first side 34 of the housing 32, as shown in FIG. 1. The power saving device 10 is placed in use in front of the television 12, as shown in FIG. 3, with the first side of the housing facing away from the television 12.

The power saving device 10 includes also a transmitter. The transmitter is capable of replicating the off signal of the television 12. The transmitter circuitry is provided within the housing 32 and a transmitter element 20 from which the signal is emitted is arranged on a second side 36 of the housing 32 opposite the first side 34. The second side 36 of the housing 32 is therefore directed in use towards the receiver 16 on the television 12.

The power saving device 10 may include a memory in which the off signal of the television is stored. Preferably, a signal receiver 38 is provided such that the signal receiver can receive the off signal from the remote control of the television 12 and store information regarding the off signal for use.

The power saving device 10 may include a store button 40 which is depressed to activate the signal receiver 38. When the store button 40 is depressed and held, a store indicator light 41 is activated to indicate that the power saving device 10 is ready to receive the signal from the remote control 14. The remote control 14 is then pointed at the signal receiver 38 and the off signal sent. The signal receiver 38 receives this signal and stores information relating to the signal in the memory such that the off signal can be reproduced by the transmitter of the power saving device 10.

Alternatively, the power saving device 10 may be provided in memory the off signals of a number of different televisions and a means to select the television 12 with which the power saving device 10 is to be used.

The power saving device 10 also includes a timer. The timer is in communication with the motion sensor and determines when a predetermined time period has elapsed since the motion sensor detected the presence of a person in the vicinity of the television 12. The timer is provided by suitable circuitry within the housing 32. The timer is also in communication with the transmitter 20 such that when the predetermined time period has elapsed, the timer causes the transmitter 20 to transmit the off signal to the television 12.

The power saving device 10 is also provided with a mode button 42 on the power saving device 10. The mode button changes the power saving device 10 between active and standby modes. An indicator, for example in the form of a status light 43, is provided to indicate the current state of the power saving device 10. The power saving device 10 may automatically switch to the standby state when the off signal is transmitted to the television 12. Also, the signal receiver 38 may detect the on signal of the remote control 14 and turn the power saving device 10 into the active mode. That is, the power saving device 10 switches itself off to conserve power when the television 12 is switched off and switches itself back on when it detects the television 12 has been turned on.

In embodiments, the device 10 advantageously maintains synchronization between the television 12 and the device 10. Various different modes of operation suitable to different applications would be clearly apparent.

In use, the power saving device 10 is placed in a location in which the motion sensor 18 can detect the presence of person in an area near the television such that those persons may be watching the television. The location is also such that the transmitter element 20 of the power saving device 10 can communicate with the receiver 16 of the television 12. As shown in FIG. 3, the power saving device 10 is preferably placed on a surface in front of the television 14 such that the first side 34 of the housing 32 is directed towards the room and the second side 36 is directed towards the receiver 16 on the television 12. In the event that the motion sensor 18 does not detect the presence of a person in the area for the predetermined time period, the power saving device 10 turns off the television display.

The predetermined time period to which the timer is set may also be variable by an operator of the power saving device 10. The operator can then set the time period to a suitable time after which they would like the television turned off. Further, the predetermined time period may include a warning period prior to switching off the television 12 in which a warning indicator alerts that no motion has been detected and that the power saving device 10 will turn off the television 12. For example, the predetermined time period may be three minutes with a warning period of 30 seconds. That is, after two and a half minutes of detecting no motion the warning indicator is activated for a period of 30 seconds before the television is turned off. The warning indicator may be provided by flashing the status light 43.

Thus the time switch determines the period of time between the last detection of motion and the time that the device will emit a signal to turn off the television.

As remote controls for televisions will often use the same signal to turn on the television as to turn it off, it will be necessary for the power saving device 10 to remain in synchronization with the television state. For example, if the television is turned off manually and this is not detected by the power saving device 10, the power saving device may send the off/on signal on detecting no motion, which would turn the television back on. The status light 43 provides one indication of synchronization in that if the television 12 has been switched off and the status light remains on, the user knows it is necessary to turn the power saving device to standby with the mode button 42.

In a further embodiment, a means to determine the state of the television may be provided. The means may comprise a display detection means to determine whether the display of the television 12 is on. The display detection means may comprise for example a light, sound or microwave based sensor. The power saving device 10 may use the information provided by the display detection means to detect that the television 12 has been manually switched off and then change the state of the power saving device 10.

The power saving device 10 may also include the ability to send an on-signal to the television 12, the on-signal being the signal sent to the television 12 by the remote control 14 to turn on the display. The function to send the on-signal may be selectable such that, when activated, the power saving device 10 sends the on-signal on detecting the presence of a person. The power saving device 10 would in this case have the ability to turn off the television display when a person leaves the room and turn it back on when the person returns to the room.

Particularly in domestic applications the device has the ability not to automatically turn the television back on when a person enters the room. In these applications the person is advantageously forced to press a button on the device to turn the television “on” as opposed to merely moving about. Thus the television does not turn on when it may not be required. Various modes of operation would be plainly apparent.

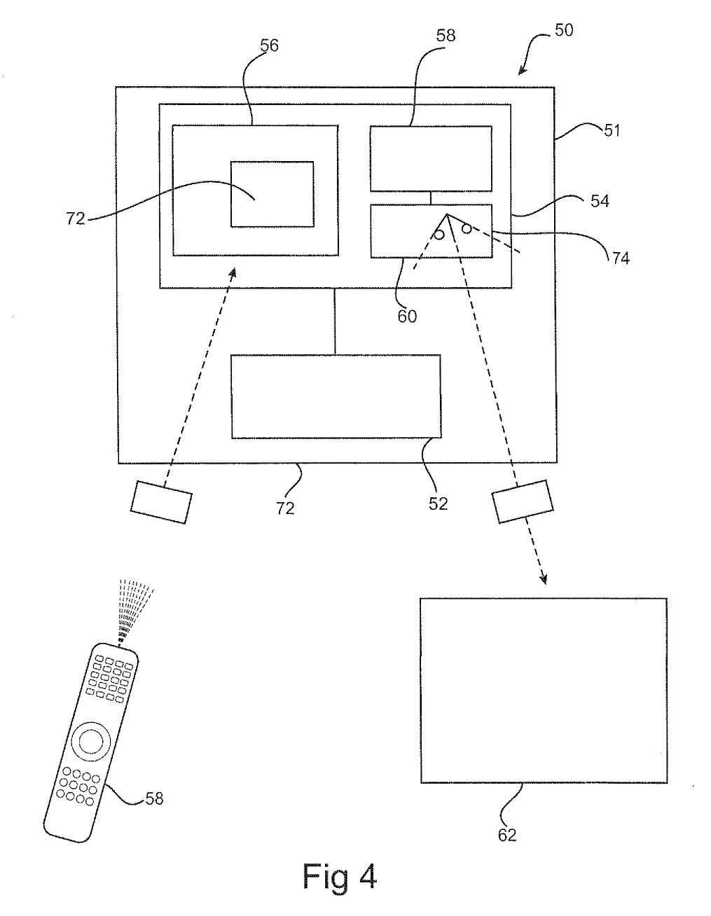

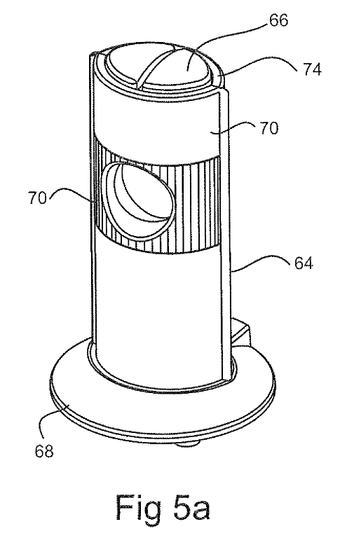

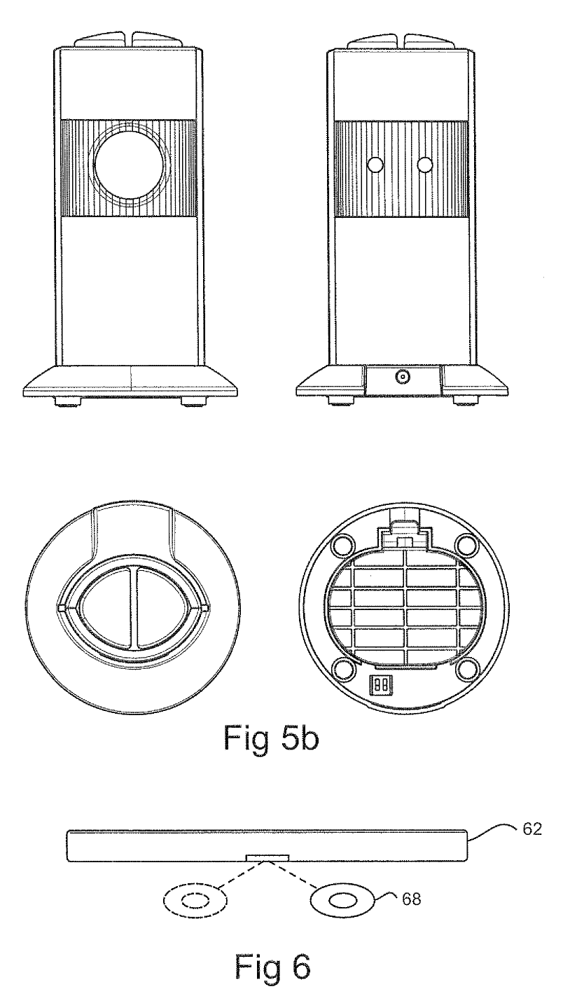

FIGS. 4, 5a, 5b and 6 show a control device 50 that comprises a housing 51 that houses a motion detector 52 and a controller 54.

The controller 54 comprises a first facility 56 for receiving a wireless signal from a remote apparatus in the form of a television remote control 58. Additionally the controller 54 includes a second facility 60 for sending a wireless signal to a remote television 62.

Advantageously the first facility 56 is arranged for changing the state of the controller 54 between a first state indicative that the display of remote television is on and showing a program, and a second state indicative that the display of the remote television is off. This is achieved by updating a parameter in a data store 58.

The first facility 56 is adapted to receive and recognize a predetermined wireless signal from the television remote control 58. Upon receiving the predetermined wireless signal the first facility 56 changes the state of the controller 54 by changing the parameter. In this embodiment this involves switching a state register, between a first and second state, in the data store 58.

The second facility 60 is adapted to selectively send the same predetermined wireless signal to the remote display apparatus when motion detector detects the absence of a person for a period of time. The selection of whether to send the signal depends on the value of the state register. This is considered to be particular beneficial for the reason that when the state register is in an “on” state the second facility will automatically send the predetermined wireless signal to the television 62. This effectively turns the television off after a predetermined amount of inactivity saving power and possibly allowing a person to sleep.

When the state register is in an “off” state the second facility 60 selectively chooses not to send the predetermined signal to the remote television 62. In this manner the device 50 advantageously maintains knowledge of the anticipated state of the television 62 by recognizing signals sent from the television remote control 58.

In the arrangement the device 50 comprises an elongate housing 64. The elongate housing 64 is arranged to stand upright by about 10cm and present change state button 66 at on a platform 74 at an elevated level. The change of state button 66 is sized to be able to be conveniently depressed using one or two fingers side by side. In the case of a typical remote control, this would not be able to be achieved because the buttons would be too small and only be able to be pressed with the tip of one's finger.

The device 50 includes a base 68 from which the housing 64 extends. The base 68 is arranged to sit on a table or television cabinet. The housing 64 includes two elongate light elements 70 that are disposed either side of the body of the housing 64.

In this embodiment the first facility 56 is used for anticipating the state of the television 62 and includes a receiver adapted to receive wireless television signal issued from the television remote 58.

In another embodiment the first facility 56 comprises a video detection unit that is adapted for physically detecting the presence of visible light originating from the television.

By being able to detect visible light the first facility 56 does not have to receive any predetermined wireless signals, with the anticipation comprising a full determination of the state of the television. The first facility 56 is preferably able to detect variations in the light provided by the display of the television and distinguish this from say the normal movement of a person. The first facility may include a light filter for detecting different characteristics of light.

In a further embodiment the first facility 56 includes an audio detection unit that is adapted to physically detect audio waves originating from a television speaker. This embodiment is presently not preferred as having the television muted will affect the performance of the system. In some arrangements it may be preferable to control sound in addition to turning the television off.

In a more practicable embodiment the first facility 54 comprises a current detection unit that is adapted to physically detect current running through a power cord supplying power to the television. It is known that current running through a wire generates an electrical and magnetic field. These fields can be detected using the principle of induction or otherwise. In a presently preferred embodiment an external induction circuit is used to detect whether the television is turned on or off. The induction circuit may be directly wired to the device 50 or be wireless. Other arrangements may use heat sensors.

In order to assist with allowing persons to sleep in front of the device 50 the controller 54 advantageously includes a threshold facility 72 for ensuring that the absence of movement for the period of time is detected only when satisfying predetermined criteria. For this purpose different forms of active and passive arrangements may be provided to sense motion.

Advantageously, in this embodiment, the threshold facility 72 ensures that the amount of movement required, in order for the presence of movement to be detected, increases with time. Consequently if a person falls asleep in front of the device 50 for say 30 minutes the device may turn off after 10 minutes due to the absence of movement. During the following 20 minutes the amount of movement required for the second facility 60 to send the predetermined signal wireless to the television 62, with the television being anticipated as being on, will increase with time. Thus the movement required after 20 minutes will be greater than the movement required after 10 minutes up to a predetermined maximum amount.

FIG. 6 shows an arrangement of the second facility 60 includes a transmitter arrangement 74 adapted to transmit the predetermined signal over a substantial portion of 180 degrees about a central position. This allows the device 50 to be placed at say about 45 degrees off centre from a standard television and for the wireless signal from the second facility 60 to still be clearly received.

More particularly the transmitter arrangement comprises two transmitters arranged to point in different directions and having an angular separation of about 30 degrees. The transmitters are positioned at an elevated position so as to be able to be positioned close to the receiver of a standard television.

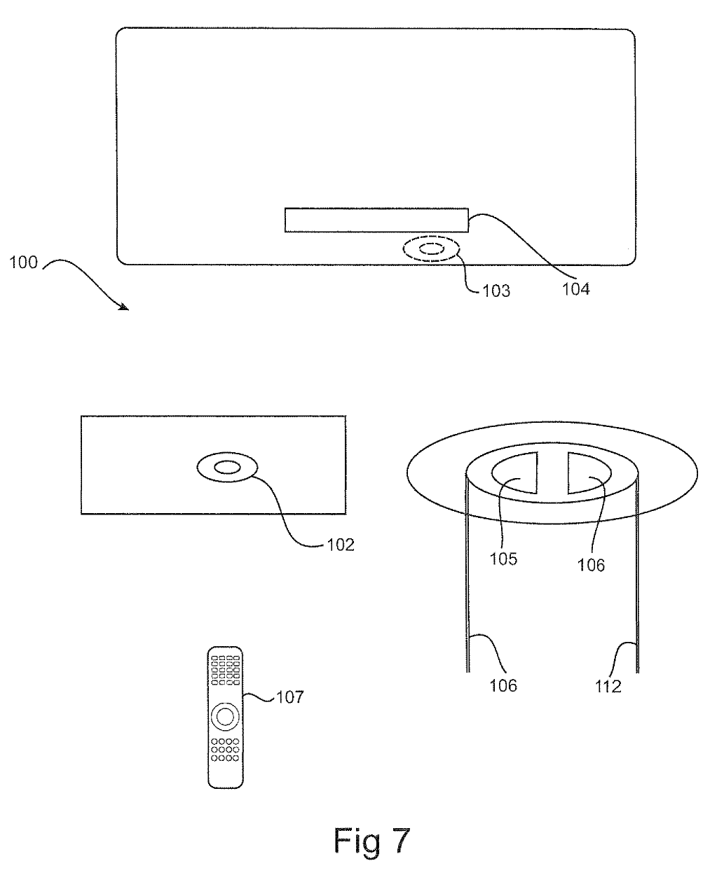

FIG. 7 shows a method 100 in which a device 102 is placed on a coffee table in front of a television 104. The device 102 is of a height less than 8 cm allowing the device to alternatively be placed in front of a conventional LCD or plasma television in a television cabinet, such as at position 103.

Following placing the device 102 on the coffee table, the device 50 is turned on by pressing an on/off button 105 disposed on an elevated platform on the top the device 102 adjacent a function button 106.

A user then depresses the function button 106 on the elevated portion of the device 102 for about 3 seconds. An elongate light 108 extending along the length of the elongate housing of the device 50 then flashes red to signify a “copy mode” of operation. In this mode the device 50 is able to read and store an infra red code sent by a conventional television remote control 107. A user presses the “on/off” button of a television remote 110 associated with the television 104, the signal is stored and the elongate light 108 subsequently stops flashing and then goes out.

Having programmed the infra signal, the user then use a switch arrangement (not shown) on the bottom of the device 102. The switch arrangement comprises an array of two dip switches allowing the user to predetermine a time period of 5 minutes (00), 8 minutes (01), 14 minutes (01) or 26 minutes(11).

The device 50 is placed back on the coffee table, with the television 104 turned off.

The function button 106 is then pressed which switches on the television 104 on by sending the stored infra red code from the device 104. This causes an elongate light 112, on an opposite side of housing to the elongate light 108 to provide a constant green signal.

In the method 100, to this point a predetermined signal has been received from a remote control device, a predetermined wireless signal stored, a time period set and the television 104 activated.

When watching the television the user will generally move around to talk, eat and drink. This will be detected by a motion sensor in the device 102 while an internal clocks count down from the set time period. The motion detector repeatedly resets the clock each time the movement of the person is detected. As a result no noticeable activity occurs whilst the user moves about during the ordinary course of watching the television.

Advantageously the user is able to repeatedly use the remote control to send wireless infra red signals to the television 104 to turn the television on and off. During such events the device 102 receives a series of the “on/off” signals from the remote control 107 and changes the state of a controller provided in the device. The controller includes memory in which a value is varied to signify whether the television has been turned on or off using the remote 107.

When the user leaves the room, with the television turned on, no movement will be detected. The absence of a movement for the predetermined period of time is sensed. After this has occurred, the device 102 wirelessly sends the stored infrared signal to the television to turn the television off.

In the method 100 this action advantageously depends on the state of the controller. Should the value stored in memory indicate that the television has been turned off by the remote 107, the device 102 will choose not to wirelessly send the stored infrared signal. Of course if the value stored in memory indicates that the television is turned on the wireless signal will be sent to the controller.

In the method 100 the light 112 flashes green 2 minutes prior to sending the signal. Using another dip switch it is possible to have the device sound an relatively quiet audible beep 30 seconds prior to sending the signal. This is considered advantageous as it is adapted not to wake a sleeping person whilst still alerting a person to the television being about to be turned off.

If the television is about to be turned off a user can press the function button 106 which will reset the clock and cause the light 112 to provide a constant green light. The ability to press the function button and reset the clock in this manner is provided during the predetermined alert period.

In this embodiment the alert period is 2 minutes long. Different embodiment may provide an alert period of 1 minute, 3 minutes or another number of minutes. If the function button 106 is pressed outside the alert period this will cause the device to send the predetermined infra red signal to turn the television off or on with the controller updating the stored value. The user does not have to use the remote control.

In order to allow a user to use the remote to prevent the television from being turned off in the alert period, the controller is adapted to send the stored infra red signal some time after receiving the signal from the remote. In this manner the remote signal will turn the television off and the controller will turn it back on and reset the clock. Due to the delay in the television turning on pressing the function button is preferred.

Advantageously the method 100 includes applying a threshold to ensure that the presence of movement is detected only when the movement meets predetermined criteria. The stringency of the threshold increases as time progresses such that an increasing amount of movement is required in order for the presence of movement to be detected.

Now that preferred embodiments of have been described in detail, it will be apparent that a number of advantages are provided over the prior art, including the following:

The ability to allow a person to fall asleep in front of a television, with the TV being turned off some predetermined period thereafter. This provides the person with quite high quality of sleep.

The ability to silently or audibly signal that no motion has been detected for a period of time and thereby provide an alert that the television is about to turned off

The ability to allow a user to stop the television from being turned off using a function key provided on the device;

The ability to allow a user to use a television remote whilst providing a motion based sleep timer whereby the absence of movement will result in a television being turned off when unattended;

Systems that reduce the amount of energy used in a household by turning off unattended televisions which may each consume upwards of 300 W; and

Systems that are convenient for the user to use and are readily positioned with respect to a standard plasma or LCD television.

It will be readily apparent to persons skilled in the relevant arts that various modifications and improvements may be made to the foregoing embodiments, in addition to those already described, without departing from the basic inventive concepts of the present invention. For example, devices may have a particular application to a television in combination with a sound system where the device turns off the television and sound system using say a wired connection between the device and the sound system and a predetermined wireless signal between the device and the television. Preferred arrangements may also be suited to projector systems and garage doors. Therefore, it will be appreciated that the scope of the invention is not limited to the specific embodiments described nor televisions per se.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. A television control device comprising:
a housing including a motion detector and a controller;
the controller comprising a first facility that anticipates a state of a television and a second facility that sends a wireless signal to the television,
wherein the first facility changes a state of the controller, between a first controller state and a second controller state; and
further wherein the second facility selectively sends a predetermined wireless signal to the television, depending on the state of the controller, in response to an absence of movement for period of time being detected with the use of the motion detector.

2. The television control device in claim 1 wherein the first facility comprises a receiver adapted to receive a predetermined wireless television signal issued from a television remote control and change the state of the controller upon the predetermined wireless signal being received.

3. The television control device in claim 2 wherein the second facility selectively sends the same predetermined wireless signal to the television.

4. The television control device in claim 1 wherein the first facility comprises a video detection unit that physically detects a presence of visible light originating from the television.

5. The television control device in claim 1 wherein the first facility comprises an audio detection unit that physically detects audio waves originating from a speaker associated with the television.

6. The television control device in claim 1 wherein the first facility comprises a current detection unit that physically detects current in a power cord supplying power to the television.

7. The television control device in claim 1 wherein the first facility comprises a current detection unit that physically detects current in an electrical cord associated with the television.

8. The television control device in claim 1 further comprising a threshold facility that ensures that an absence of movement is detected only when satisfying predetermined criteria.

9. The television control device in claim 8 wherein the threshold facility ensures that an amount of movement, required for the presence of movement to be detected, increases with time.

10. The television control device in claim 1 wherein the device is positionable adjacent a television receiver included with the television.

11. The television control device in claim 10 wherein the second facility includes a transmitter arrangement transmitting the predetermined signal at least 60 degrees either side of a central position.

12. The television control device in claim 11 wherein the transmitter arrangement comprises two transmitters arranged at 30 degrees.

13. A television control device comprising:
a housing including a motion detector and a controller;
the controller including a transmitter sending a predetermined wireless signal for controlling a state of a television and a memory storing a value indicative of an anticipated state of the television;
the housing stands upwardly and provides an elevated platform;
the platform providing a depressible state selection button that when actuated changes an value indicative of the anticipated state of the television.

14. The television control device in claim 13 wherein the housing extends at least 7 cm.

15. The television control device in claim 14 wherein the state selection button is sized to be pressed with an underside of an index finger.

16. The television control device in claim 13 including a receiver receiving the predetermined wireless signal from a television remote control, the receiver being connected to the memory for changing the stored value in anticipation of a change in state of the television.

17. A control device comprising:
a housing including a motion detector and controller;
the controller including a first facility used for anticipating the state of a remote apparatus and a second facility for sending a wireless signal to a second remote apparatus associated with a display;
wherein the first facility changes a state of the controller between a first controller state and a second controller state; and
the second facility selectively sends a predetermined wireless signal to the second remote apparatus, depending on the state of the controller, in response to an absence of movement during a period of time being detected using the motion detector.

18. A method of controlling a television comprising:
providing a control device having a motion detector and a controller;
receiving a predetermined signal from a remote control device and changing the state of the controller in accordance therewith;
sensing the absence of a movement for a predetermined amount of time; and
once the absence of movement has been detected, wirelessly sending the predetermined wireless signal to a television, depending on the state of the controller.

19. The method in claim 18 including applying a threshold to ensure that the presence of movement is detected only when the movement meets predetermined criteria.

20. The method in claim 18 including increasing the threshold as time progresses such that an increasing amount of movement is required in order for the presence of movement to be detected.

21. The method in claim 18 including providing a button which when depressed changes the state of the controller and sends the predetermined wireless signal to the television.

22. A power saving device for switching off an electrical appliance having a receiver receiving an off signal from an associated remote control, the power saving device comprising:
a motion sensor for detecting a presence of a person in the vicinity of the appliance, and
a transmitter replicating the off signal of the remote control, wherein in the transmitter sends the off signal to the appliance when the motion sensor does not detect the presence of a person in the vicinity of the appliance for a predetermined time period.

23. The power saving device in claim 22 wherein the appliance comprises a television and the transmitter sends the off signal to the television after the predetermined time has elapsed to turn off the television display.

24. The power saving device in claim 23 including a signal receiver to receive the off signal from the remote control of the television and store information regarding the off signal in a memory for use.

25. The power saving device in claim 24 including a store button which, when depressed, places the power saving device into a store mode in which the off signal is received by the signal receiver and stored in memory; and a mode button changing the power saving device between an active mode and a standby mode.

26. The power saving device in claim 22 including a logic unit determining a state of the television display.
